(19) United States
(12) Patent Application Publication
(10) Pub. No.: US 2018/0042022 A1
(43) Pub. Date: Feb. 8, 2018

(54) WIRELESS COMMUNICATION SYSTEM AND ASSOCIATED METHOD

(71) Applicant: MEDIATEK INC., Hsin-Chu (TW)

(72) Inventors: Weisung Tsao, Fremont, CA (US); Shihchieh Lee, Mountain View, CA (US); Chung-Ta Ku, Kaohsiung City (TW); Chia-Hung Tsai, Santa Clara, CA (US); Cheng-Hsi Marik Hsiao, Santa Clara, CA (US); Po-Yuen Cheng, San Jose, CA (US)

(21) Appl. No.: 15/666,580

(22) Filed: Aug. 2, 2017

Related U.S. Application Data
(60) Provisional application No. 62/369,786, filed on Aug. 2, 2016.

(51) Int. Cl. H04W 72/04

(52) U.S. Cl. CPC H04W 72/0473; H04W 72/042

(57) ABSTRACT

A wireless communication system includes an access point and at least one station. The access point sends a trigger frame including power information for indicating a targeted receive power of data sent from the at least one station to the access point and an output power of the target frame. Each of the at least one station sends data to the access point by referring to the targeted power.

### CROSS REFERENCE TO RELATED APPLICATIONS

This application claims the benefit of U.S. Provisional Application No. 62/369,786 filed on Aug. 2, 2016, the contents of which are incorporated herein by reference.

### BACKGROUND

In the IEEE 802.11ax standard, multiple transmitters are allowed to transmit at different sub-carriers simultaneously in a multi-user system, where said multi-user system may be, but not limited to, an Orthogonal Frequency-Division Multiple Access (OFDMA) system, a Multi-input Multi-output (MIMO) system, etc. Therefore, the receiver needs to demodulate signals that are transmitted from multiple transmitters using different transmission powers and experience different attenuations, which may introduce some challenges for the receiver's design. For instance, higher power transmitters may leak energy to adjacent sub-bands which causes the incorrect receiving of the packets for the receiver. For another instance, the difficulty of the implementations of the automatic gain control (AGC) and the demodulator of the receiver increases due to the limited dynamic range and the limited sensitivity of the receiver. Therefore, a novel design for the receiver in a multi-user system is desired.

### SUMMARY

One of the objectives of the present invention is to provide a wireless communication system and an associated method to solve the abovementioned problems.

According to an embodiment of the present invention, an exemplary wireless communicating method employed by an access point is disclosed. The exemplary wireless communicating method comprises: sending a trigger frame to at least one station, wherein the trigger frame comprises power information indicating a targeted receive power of data sent from the at least one station to the access point and an output power of the trigger frame; and receiving the data sent from the at least one station.

According to an embodiment of the present invention, an exemplary wireless communicating method employed by a station is disclosed. The exemplary wireless communicating method comprises: receiving a trigger frame from an access point, wherein the trigger frame comprises power information indicating a targeted receive power and an output power of the trigger frame; and sending data to the access point by referring to at least the targeted power.

According to an embodiment of the present invention, an exemplary wireless communication system is disclosed. The exemplary wireless communication system comprises: an access point; and at least one station; wherein the access point sends a trigger frame comprising power information for indicating a targeted receive power of data sent from the at least one station to the access point and an output power of the target frame, and the at least one station sends data to the access point by referring to the targeted power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is a diagram illustrating a format of a trigger frame according to an embodiment of the present invention.

FIG. 3 is a diagram illustrating the communication between an access point and stations comprised in a wireless communication system according to an embodiment of the present invention.

FIG. 4 is a diagram illustrating the communication between an access point and stations comprised in a wireless communication system before transmitting a trigger frame according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

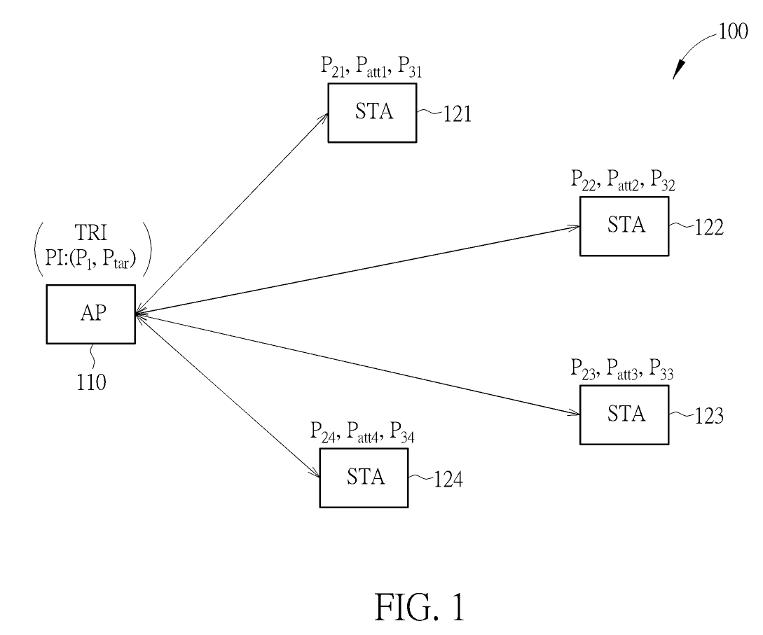

FIG. 1 is a diagram illustrating a wireless communication system 100 according to an embodiment of the present invention. The wireless communication system 100 may include at least one access point (AP) and at least one station (STA). As shown in FIG. 1, the wireless communication system 100 comprises one access point (AP) 110 and a plurality of stations (STAs) 121, 122, 123, 124. The number of APs comprised in the wireless communication system 100 and the number of STAs comprised in the wireless communication system 100 are not meant to be limitations of the present invention. For example, in other embodiments, the wireless communication system 100 can comprise multiple APs each communicating with one or more STAs. The AP 110 is arranged to transmit a trigger frame TRI to STAs 121-124, wherein the trigger frame TRI comprises power information PI indicating a targeted power Pₜₐᵣ which implies the desired received power for the AP 110 receiving data from the STAs 121-124, and further indicating a power P₁ which implies the transmitting power for the AP 110 transmitting the trigger frame TRI to the STAs 121-124. The STA 121 determines a power P₂₁ implying the received power when the trigger frame TRI is received by the STA 121. The power P₂₁ can be determined according to, for example, a Received Signal Strength Indicator (RSSI) of the trigger frame TRI . After determining the power P₂₁, the STA 121 calculates a transmission attenuation Pₐₜₜ₁ between the STA 121 and the access point 110 by the equation: Pₐₜₜ₁=P₁−P₂₁. The STA 121 then calculates a power P₃₁ by the equation: P₃₁=Pₐₜₜ₁+Pₜₐᵣ, and transmits data to the AP 110 by referring to the power P₃₁. It should be noted that the STA 121 may not be able to transmit data with the power P₃₁ exactly due to the limitation of hardware or other factors. In one embodiment, the STA 121 transmits data with the transmitting power as close to the power P₃₁ as possible. For example, if the calculated power P₃₁ is −10 dBm and the lowest power of the STA 121, however, is 0 dBm, the STA 121 transmits data to the AP 110 with the lowest power 0 dBm therefore.

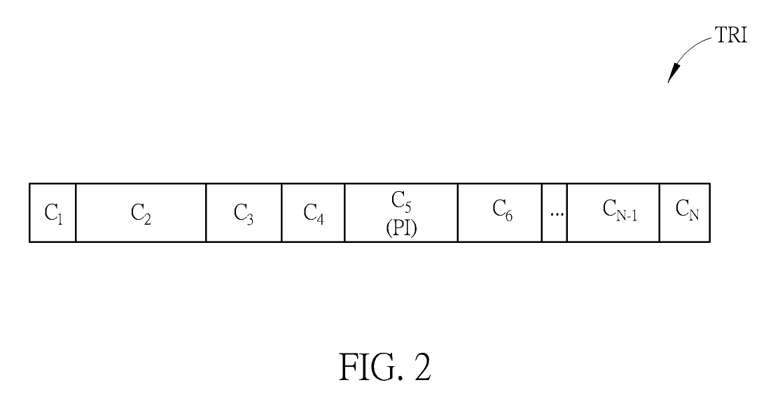

FIG. 2 is a diagram illustrating a format of the trigger frame TRI according to an embodiment of the present invention. The trigger frame TRI comprises a plurality of fields C1-Cn, wherein the field C5, such as a common information field, is arranged to store the power information PI. However, this is only for illustrative purpose. In other embodiments, the power information PI can be stored in a different place in the trigger frame TRI. In addition, the targeted power Pₜₐᵣ and the power PI can be recorded in the power information PI in any form. For example, 4 bits of the power information PI are arranged to interpret the power P₁ in units of 2 dBm, and 4 bits of the power information PI are arranged to interpret the target power Pₜₐᵣ in units of −10 dBm. However, this is only for illustrative purpose as well, not a limitation of the present invention.

Referring to FIG. 1 again, the STA 122 determines a power P₂₂ implying the received power when the trigger frame TRI is received by the STA 122. The power P₂₂ can be determined according to, for example, a Received Signal Strength Indicator (RSSI) of the trigger frame TRI. After determining the power P₂₂, the STA 122 calculates a transmission attenuation Pₐₜₜ₂ between the STA 122 and the access point 110 by the equation: Pₐₜₜ₂=P₁−P₂₂.The STA 122 then calculates a power P₃₂ by the equation: P₃₂=Pₐₜₜ₂+Pₜₐᵣ, and transmits data to the AP 110 by referring to the power P₃₂. It should be noted that the STA 122 may not be able to transmit data with the power P₃₂ exactly due to the limitation of hardware or other factors. In one embodiment, the STA 122 transmits data with the transmitting power as close to the power P₃₂ as possible. For example, if the calculated power P₃₂ is −10 dBm and the lowest power of the STA 122, however, is 0 dBm, the STA 122 transmits data to the AP 110 with the lowest power 0dBm thereby.

Likewise, the STA 123 determines a power P₂₃ implying the received power when the trigger frame TRI is received by the STA 123. The power P₂₃ can be determined according to, for example, a Received Signal Strength Indicator (RSSI) of the trigger frame TRI. After determining the power P₂₃, the STA 123 calculates a transmission attenuation Pₐₜₜ₃ between the STA 123 and the access point 110 by the equation: Pₐₜₜ₁=P₁−P₂₃ . The STA 123 then calculates a power P₃₃ by the equation: P₃₃ =Pₐₜₜ₃+Pₜₐᵣ, and transmits data to the AP 110 by referring to the power P₃₃. It should be noted that the STA 123 may not be able to transmit data with the power P₃₃ exactly due to the limitation of hardware or other factors. In one embodiment, the STA 123 transmits data with the transmitting power as close to the power P₃₃ as possible. For example, if the calculated power P₃₃ is −10 dBm and the lowest power of the STA 123, however, is 0 dBm, the STA 123 transmits data to the AP 110 with the lowest power 0 dBm thereby.

In addition, the STA 124 determines a power P₂₄ implying the received power when the trigger frame TRI is received by the STA 124. The power P₂₄ can be determined according to, for example, a Received Signal Strength Indicator (RSSI) of the trigger frame TRI. After determining the power P₂₄, the STA 124 calculates a transmission attenuation Pₐₜₜ₄ between the STA 124 and the access point 110 by the equation: Pₐₜₜ₄=P₁−P₂₄. The STA 124 then calculates a power P₃₄ by the equation: P₃₄=Pₐₜₜ₄+Pₜₐᵣ, and transmits data to the AP 110 by referring to the power P₃₄. It should be noted that the STA 124 may not be able to transmit data with the power P₃₄ exactly due to the limitation of hardware or other factors. In one embodiment, the STA 124 transmits data with the power as close to the power P₃₄ as possible. For example, if the calculated power P₃₄ is −5 dBm and the lowest power of the STA 124 is −15 dBm, the STA 124 transmits data to the AP 110 with the lowest power −5 dBm thereby.

It should be noted that the trigger frame TRI can be further arranged to allocate a subcarrier (or a resource unit) to each STA for transmitting data to the AP 110. The skilled in the art should easily understand the implementation of assigning a resource unit to each STA, and the detailed description is omitted here for brevity.

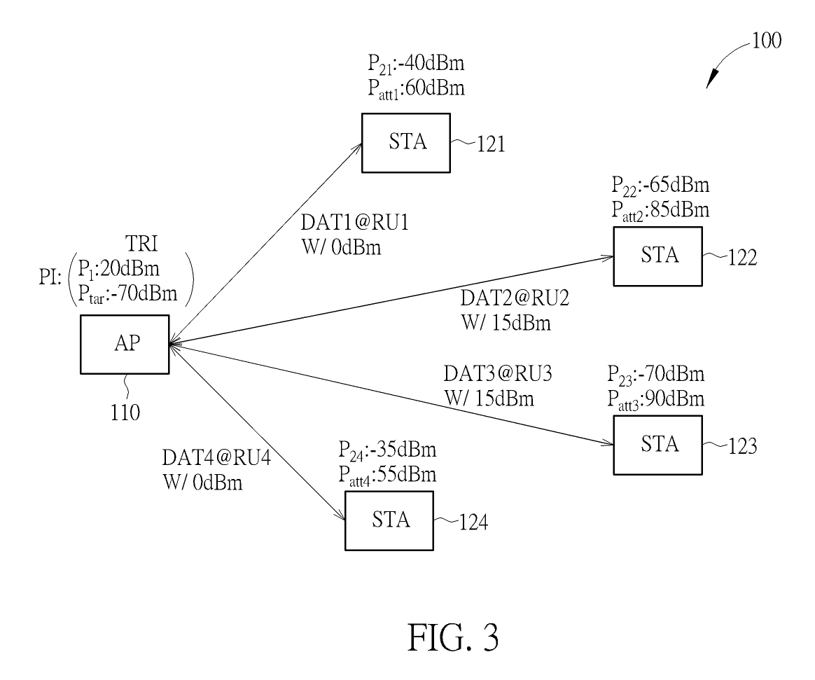

FIG. 3 is a diagram illustrating the communication between the AP 110 and STAs 121-124 comprised in the wireless communication system 100 according to an embodiment of the present invention. As shown in FIG. 3, the AP 110 transmits a trigger frame TRI comprising the power information PI to the STAs 121-124, wherein the power information PI indicates the power P₁ implying the transmitting power for the AP 110 transmitting the trigger frame TRI to the STAs 121-124 is 20 dBm and the targeted power Pₜₐᵣ implying the desired received power for the AP 110 receiving data from the STAs 121-124 is −70 dBm. The STA 121 receives the trigger frame TRI and determines the power P₂₁ implying the received power when the trigger frame TRI is received by the STA 121 is −40 dBm, wherein the trigger frame TRI also allocates a resource unit RU1 to the STA 121 for transmission. The transmission attenuation Pₐₜₜ₁ between the STA 121 and the AP 110 is 60 dBm decided by the equation: Pₐₜₜ₁=P₁−P₂₁, and the power P₃₁ is −10 dBm decided by the equation: P₃₁=Pₐₜₜ₁+Pₜₐᵣ The lowest transmission power of the STA 121, however, is 0 dBm. Hence, the STA 121 transmits a data DAT1 at the resource unit RU1 with the power 0 dBm.

The STA 122 receives the trigger frame TRI and determines the power P₂₂ implying the received power when the trigger frame TRI is received by the STA 122 is −65 dBm, wherein the trigger frame TRI also allocates a resource unit RU2 to the STA 122 for transmission. The transmission attenuation Pₐₜₜ₂ between the STA 122 and the AP 110 is 85 dBm decided by the equation: Pₐₜₜ₂=P₁−P₂₂, and the power P₃₂ is 15 dBm decided by the equation: P₃₂=Pₐₜₜ₂=Pₜₐᵣ. The STA 122 thus transmits a data DAT2 at the resource unit RU2 with the power 15 dBm.

The STA 123 receives the trigger frame TRI and determines the power P₂₃ implying the received power when the trigger frame TRI is received by the STA 123 is −70 dBm, wherein the trigger frame TRI also allocates a resource unit RU3 to the STA 123 for transmission. The transmission attenuation Pₐₜₜ₃ between the STA 123 and the AP 110 is 90 dBm decided by the equation: Pₐₜₜ₁=P₁−P₂₃, and the power P₃₃ is 20 dBm decided by the equation: P₃₃=^{P}ₐₜₜ₃+Pₜₐᵣ However, the maximum transmission power of the STA 123 is limited to 15 dBm, the STA 123 thus transmits a data DAT3 at the resource unit RU3 with the power 15 dBm.

The STA 124 receives the trigger frame TRI and determines the power P₂₄ implying the received power when the trigger frame TRI is received by the STA 124 is −35 dBm, wherein the trigger frame TRI also allocates a resource unit RU1 to the STA 124 for transmission. The transmission attenuation Pₐₜₜ₄ between the STA 124 and the AP 110 is 55 dBm decided by the equation: Pₐₜₜ₄=P₁−P₂₄,and the power P₃₄ is −15 dBm decided by the equation: P₃₄=Pₐₜₜ₄+Pₜₐᵣ . The transmission power of the STA 124 in this embodiment is not limited by hardware capability. Hence, the STA 124 transmits a data DAT4 at the resource unit RU4 with the power −15 dBm.

It should be noted that in the embodiment of FIG. 3, the transmission attenuations Pₐₜₜ₁−Pₐₜₜ₄ mainly result from the distances between the AP 110 and the STAs 121-124. For example, the transmission attenuation Pₐₜₜ₂ is greater than the transmission attenuation Pₐₜₜ₁ because the STA 122 is further than the STA 121 as shown in FIG. 3. However, in addition to the distance between the STA and the AP, the transmission attenuation may also depend upon other factors such as obstacles (e.g., buildings) between the STAs 121-124 and the AP 110. Therefore, the relative location between the AP 110 and the STA 121-124 shown in FIG. 1 and FIG. 3 is only illustrative, not a limitation of the present invention.

By indicating the target power Pₜₐᵣ in the trigger frame TRI, the receiver (i.e. AP 110) can receive data (i.e. DAT1-DAT4) transmitted with similar powers by multiple transmitters/users (i.e. STAs 121-124). In this way, the incorrect receiving issue mentioned in the prior art can be solved.

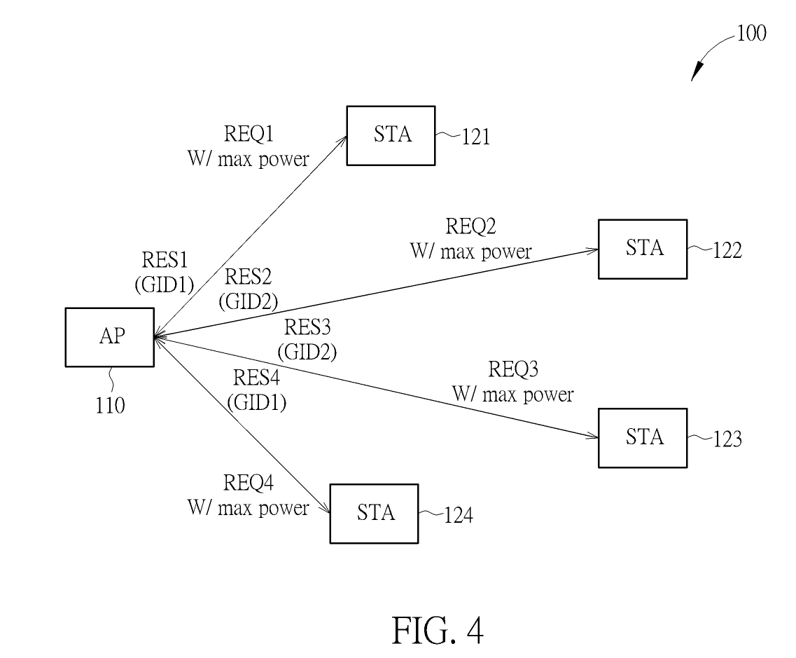

In order to prevent the higher power transmitters from leaking energy to adjacent sub-bands, the present invention further proposes an operation of categorizing the STAs 121-124 into groups based on the distance (or the transmission attenuation) by assigning a group ID to each STA before transmitting the trigger frame TRI. Referring to FIG. 4 which is a diagram illustrating the communication between the AP 110 and the STAs 121-124 comprised in the wireless communication system 100 before transmitting the trigger frame TRI according to an embodiment of the present invention, STAs 121-124 initially transmit communication requests REQ1-REQ4 to the AP 110 with max power for starting a communication, wherein the communication request REQ1-REQ4 can be, but not limited to, association requests, probe requests, OFDMA requests, or data packets. When the communication requests REQ1-REQ4 transmitted with max power of respective STAs 121-124 are received by the AP 110, the AP 110 determines the relative distance between STAs 121-124 and the AP 110 based on the received power of each communication request, wherein the received power of each communication request can be determined by the RSSI of each communication request. For example, the AP 110 determines that the STAs 121 and 124 are relatively closer than the STAs 122 and 123 due to the received powers of the communication requests REQ1 and REQ4 are greater than that of the communication requests REQ 2 and REQ3. By this, the AP 110 categorizes STAs 121 and 124 into group 1 by assigning a group identity GID1 in communication responses RES 1 and RES 4 generated in response to the communication requests REQ 1 and REQ4, respectively, and categorizes STAs 122 and 123 into group 2 by assigning a group identity GID2 in communication responses RES 2 and RES 3 generated in response to the communication requests REQ2 and REQ3, respectively. After assigning the group identities GID1 and GID2 to the STAs 121-124, the AP 110 then can assign one of the group identities GID1 and GID2 in the trigger frame TRI shown in the embodiment of FIG. 3 to ask the STAs corresponding to the assigned group identity to transmit data. For example, the AP 110 specifically indicates the group identity GID1 in the trigger frame TRI. When the STAs 121-124 receive the trigger frame TRI, only the STAs corresponding to the group identity GID1 (i.e. STAs 121 and 124) are allowed to transmit data. Next, the AP 110 specifically indicates the group identity GID2 in the next trigger frame TRI. When the STAs 121-124 receive the trigger frame TRI, only the STAs corresponding to the group identity GID2 (i.e. STAs 122 and 123) are allowed to transmit data. By assigning group identity to STAs 121-124, the STAs closer to the AP 110 can transmit data corresponding to a trigger frame simultaneously while the STAs relatively further to the AP 110 can transmit data corresponding to another trigger frame simultaneously. In this way, during each communication period, the data packets from the STAs to the AP 110 are transmitted with similar/same powers, thus effectively avoiding the incorrect receiving of lower-power sub-band transmission interfered with adjacent higher-power sub-channel transmission.

In random access, any STA (e.g. the STAs 121-124) could try to contend using any RU for transmission. In this case, the present invention presents a solution by assigning the group identities to each STA. For example, the group identity GID1 to the STAs 121 and 124 while the group ID GID2 to the STAs 122 and 123. The AP 110 sends the trigger frame TRI including one of the group identities GID1 and GID2 to let all the STAs (e.g. the STAs 121-124) know which STA could send data after the trigger frame TRI.

In another embodiment, the AP 110 may send the trigger frame TRI to those STAs with the same group identity (e.g. one of the group IDs GID1 and GID2) , wherein the trigger frame TRI specifies that which STA uses which RU for transmission without including the group identity therein. For example, the AP 110 sends the trigger frame TRI to those STAs with the group identity GID1 (i.e. the STAs 121 and 124), wherein the trigger frame TRI specifies that the STA 121 uses the RU1 for transmission while the STA 124 uses the RU4 for transmission without including the group identity therein. Likewise, the AP 110 sends the trigger frame TRI to those STAs with the group identity GID2 (i.e. the STAs 122 and 123) , wherein the trigger frame TRI specifies that the STA 122 uses the RU2 for transmission while the STA 123 uses the RU3 for transmission without including the group identity therein.

Referring to FIG. 2, the group identity may be assigned in any of the fields C1-Cn comprised in the trigger frame TRI. The location of the group identity recorded in the trigger frame TRI specified by the AP 110 is not a limitation of the present invention as long as the same goal can be achieved.

Briefly summarized, the present invention proposes a wireless communication system and associated method which can effectively solve the problems described in the prior art by indicating a targeted power in the trigger frame to achieve power control and categorizing the STAs into groups with group identities in communication responses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communicating method employed by an access point, comprising:
sending a trigger frame to at least one station, wherein the trigger frame comprises a power information indicating a targeted power of data sent from the at least one station to the access point; and
receiving the data sent from the at least one station.

2. The wireless communicating method of claim 1, wherein the power information further indicates a power for the access point transmitting the trigger frame.

3. The wireless communicating method of claim 1, further comprising:
before sending the trigger frame:
receiving a communication request sent from each of the at least one station; and
sending a communication response to said each of the at least one station in response to the communication request, wherein the access point categorizes the at least one station into at least one station group by specifying a group identity in the communication response, and the group identity is specified by referring to a received power of the communication request sent from said each of the at least one station.

4. The wireless communicating method of claim 3, wherein the trigger frame sent from the access point further comprises a designated group identity indicating which one of the at least one station group is allowed to send data to the access point.

5. The wireless communicating method of claim 3, wherein the at least one station group is one station group being specified a specific group identity, and the trigger frame further specifies a resource unit to each of the at least one station for transmitting the data.

6. A wireless communicating method employed by a station, comprising:
receiving a trigger frame from an access point, wherein the trigger frame comprises a power information indicating a targeted power; and
sending data to the access point by referring to at least the targeted power.

7. The wireless communicating method of claim 6, wherein the power information further indicates a first power for the access point transmitting the trigger frame.

8. The wireless communicating method of claim 7, wherein sending the data by referring to at least the targeted power comprises:
determining a second power of the trigger frame received at the station;
calculating a transmission attenuation between the station and the access point according to the first power and the second power; and
sending the data to the access point by referring to the targeted power and the transmission attenuation.

9. The wireless communicating method of claim 8, wherein the transmission attenuation is calculated by a following equation:
Pₐₜₜ=P₁−P₂;
where Pₐₜₜ is the transmission attenuation, P₁ is the first power, and P₂ is the second power.

10. The wireless communicating method of claim 8, wherein sending data to the access point by referring to the targeted power and the transmission attenuation comprises:
calculating a third power by a following equation:
P₃=Pₜₐᵣ+Pₐₜₜ;
where P₃ is the third power, Pₐₜₜ is the transmission attenuation and Pₜₐᵣ is the targeted power; and
sending the data to the access point by referring to the third power.

11. The wireless communicating method of claim 6, further comprising:
before receiving the trigger frame:
sending a communication request to the access point; and
receiving a communication response send from the access point in response to the communication request, wherein the communication response comprises a group identity of the station, wherein the group identity specifies a station group to which the station belongs.

12. The wireless communicating method of claim 11, wherein the station sends the data to the access point in response to the trigger frame indicating the group identity.

13. The wireless communicating method of claim 11, wherein the trigger frame further specifies a resource unit to the station for transmitting the data.

14. A wireless communication system, comprising:
an access point; and
at least one station;
wherein the access point sends a trigger frame comprising a power information for indicating a targeted power of data sent from the at least one station to the access point, and each of the at least one station sends data to the access point by referring to the targeted power.

15. The wireless communication system of claim 14, wherein the power information further indicates a first power for the access point transmitting the trigger frame.

16. The wireless communication system of claim 15, wherein said each of the at least one station determines a second power of the trigger frame received at said each of the at least one station, calculates a transmission attenuation between said each of the at least one station and the access point according to the first power and the second power, and sends the data to the access point by referring to the targeted power and the transmission attenuation.

17. The wireless communication system of claim 16, wherein the transmission attenuation is calculated by a following equation:
Pₐₜₜ=P₁−P₂;
where Pₐₜₜ is the transmission attenuation, P₁ is the first power, and P₂ is the second power.

18. The wireless communication system of claim 16, wherein said each of the at least one station calculates a third power by a following equation:
P₃=Pₜₐᵣ+Pₐₜₜ ;
where P₃ is the third power, Pₐₜₜ is the transmission attenuation and Pₜₐᵣ is the targeted power; and
said each of the at least one station sends the data to the access point by referring to the third power.

19. The wireless communication system of claim 14, wherein before sending the trigger frame, the access point receives a communication request sent from said each of the at least one station, and sends a communication response to said each of the at least one station in response to the communication request, wherein the access point categorizes the at least one station into at least one station group by specifying a group identity in the communication response, and the group identity is specified by referring to a received power of the communication request sent from said each of the at least one station.

20. The wireless communication system of claim 19, wherein the trigger frame sent from the access point further comprises a designated group identity indicating which one of the at least one station group is allowed to send data to the access point.
